(19) United States
(12) Patent Application Publication
(10) Pub. No.: US 2015/0242516 A1
(43) Pub. Date: Aug. 27, 2015

(54) MULTI-LATERAL NETWORK COMMUNICATION FOR SALE OF VEHICLES

(71) Applicant: Fastrak Companies International, LLC, Carnesville, GA (US)

(72) Inventor: R. Stan Lester, Carnesville, GA (US)

(21) Appl. No.: 14/630,746

(22) Filed: Feb. 25, 2015

Related U.S. Application Data
(60) Provisional application No. 61/944,196, filed on Feb. 25, 2014.

(51) Int. Cl. G06F 17/30; H04L 29/08; G06F 3/0481; G06Q 30/06; G06F 3/0482

(52) U.S. Cl. CPC G06F 17/30867; G06F 17/3087; G06F 17/30244; G06Q 30/0627; G06F 3/0482; G06F 3/04817; H04L 67/10

(57) ABSTRACT

Disclosed are various embodiments for providing bi-lateral communication between two or more dealers having a network presence. A computing device is configured to receive a request for a vehicle matching predefined criteria from a client device over a network. The computing device identifies dealers located within a predefined distance of the user generating the request by querying a database residing in a data store. A communication is sent to the dealers located within the predefined distance comprising the vehicle and the predefined criteria and a communication session is generated in a user interface in response to the corresponding one of the plurality of dealers having the item required by the user. The communication session is configured to facilitate communication between the user and the dealer.

### CROSS-REFERENCE TO RELATED APPLICATION

This application claims the benefit of and priority to co-pending U.S. Provisional Patent Application No. 61/944,196 entitled “METHOD AND SYSTEM FOR SALE OF VEHICLES,” filed Feb. 25, 2014, which is incorporated by reference herein in its entirety.

### BACKGROUND

During the normal course of business in an automotive dealership, potential customers regularly make requests for a specific vehicle. In the event the automotive dealership does not have the specific vehicle in its inventory, the automotive dealership may locate one by contacting local dealerships. This may require an employee of the automotive dealership to manually phone or e-mail local dealerships unsure of whether one of the local dealerships has the specific vehicle in its inventory and, in the event one of the local dealerships has the specific vehicle, the employee remains unsure of the price, condition, or other characteristics of the specific vehicle.

Alternatively, the employee of the automotive dealership may conduct a search on numerous search engines to locate nearby dealerships. The employee may use the search engine to determine a webpage corresponding to a respective local dealership and to access the webpage of the local dealership to navigate through its inventory. An incomplete or out-of-date inventory may leave the employee unable to determine whether the local dealership has the specific vehicle in its inventory. Accordingly, the normal course of business of locating a specific vehicle from local dealers remains problematic.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing of a communication component that facilitates communication between or among a plurality of dealers according to various embodiments of the present disclosure.

FIG. 2 is a drawing of a networked environment according to various embodiments of the present disclosure.

FIG. 3 is a pictorial diagram of an example user interface rendered by a client in the networked environment of FIG. 2 according to various embodiments of the present disclosure.

FIG. 4 is a pictorial diagram of an example user interface rendered by a client in the networked environment of FIG. 2 according to various embodiments of the present disclosure.

FIG. 5 is a pictorial diagram of an example user interface comprising the communication component of FIG. 1 and rendered by a client in the networked environment of FIG. 2 according to various embodiments of the present disclosure.

FIG. 6 is a pictorial diagram of an example user interface rendered by a client in the networked environment of FIG. 2 according to various embodiments of the present disclosure.

FIG. 7 is a flowchart illustrating one example of functionality implemented as portions of an application executed in a computing environment in the networked environment of FIG. 2 according to various embodiments of the present disclosure.

FIG. 8 is a flowchart illustrating one example of functionality implemented as portions of an application executed in a computing environment in the networked environment of FIG. 2 according to various embodiments of the present disclosure.

FIG. 9 is a schematic block diagram that provides one example illustration of a computing environment employed in the networked environment of FIG. 2 according to various embodiments of the present disclosure.

### DETAILED DESCRIPTION

During the normal course of business in an automotive dealership, or similarly business, potential customers regularly make requests for a specific item, such as a particular automobile. For example, a potential customer may visit a dealer to determine whether the dealer is able to offer a 1967 Chevrolet® Camaro for sale. In the event the automotive dealership does not have a '67 Camaro in its inventory, the automotive dealership may attempt to locate one by contacting local dealerships. This may require an employee of the automotive dealership to manually phone or e-mail local dealerships while being unsure of whether one of the local dealerships has a '67 Camaro in its inventory and, in the event one of the local dealerships has a '67 Camaro, the employee remains unsure of the price, condition, or other characteristics of the specific vehicle.

Alternatively, the employee of the automotive dealership may conduct a search on numerous search engines to locate nearby dealerships. The employee may use the search engine to determine a webpage corresponding to a respective local dealership and to access the webpage of the local dealership to navigate through its inventory. An incomplete or out-of-date inventory may leave the employee unable to determine whether the local dealership has the specific vehicle in its inventory. Accordingly, the normal course of business of locating a specific item, such as an automobile, an all-terrain vehicle (ATV), a boat, a recreational vehicle (RV), etc., remains problematic.

A network- or cloud-based system may be operable to communicate with a plurality of dealerships to maintain an up-to-date inventory of a plurality of items in an inventory corresponding to each of the dealerships, where the user may be able to obtain a product page comprising various characteristics of a specific item of inventory, such as the price, color, make, model, condition, etc. The system may provide a user with a component to search for specific items in various inventories corresponding to the dealerships. Further, a component may be configured to provide a real-time communication session between dealers. In the following discussion, a general description of the system and its components is provided, followed by a discussion of the operation of the same. According to various embodiments, the system described herein may be employed, for example, in the whole-sale or retail-sale of items such as all terrains vehicles (ATVs), motorcycles, recreational vehicles (RVs), campers, boats, automobile vehicles and/or other items.

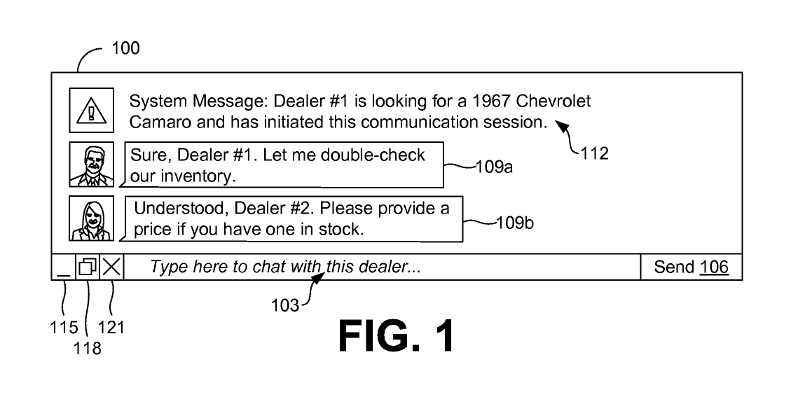

With reference to FIG. 1, shown is an example communication component 100 that may be employed to facilitate real-time communication among a plurality of dealers. In the non-limiting example of FIG. 1, a communication component may comprise, for example, an input component 103, a send component 106, and/or various other components as will be described. The input component 103 may be configured to receive text generated by a client device. As may be appreciated, a client device may be configured to generate text based on input provided to the client device via a keyboard, mouse, speech recognition software, gesture recognition software, etc., in response to actions performed by a user of the client device.

The communication component 100 accordingly may receive input from one dealer and, in real-time or near real-time, communicate the input to one or more other dealers in response to a user manipulating or engaging the send component 103. The communication component 100 may comprise one or more messages 109a and 109b that may be have been communicated by respective dealers. According to various embodiments, upon initiating a communication session, the system may provide context of the communication session in the form of a system message 112. The system message 112 may comprise at least an item searched by one of the dealers which led to the initiation of the communication session facilitated by the communication component 100, as will be discussed in greater detail below.

The communication component 100 may further provide various components that may facilitate a viewing of the communication session. For example, the communication component 100 may comprise a minimize component 115, a maximize component 118, and/or a close component 121. The minimize component 115 may be configured to minimize or otherwise reduce the size of the communication component 100 respective of a user interface, a network page, and/or an operating system. Similarly, the maximize component 118 may be configured to maximize or otherwise increase the size of the communication component 100 respective of a user interface, a network page, and/or an operating system. The close component 121 may be configured to close or otherwise terminate a rendering of the communication component 100 respective of a user interface, a network page, and/or an operating system.

According to various embodiments, the communication component 100 may be configured as a software widget for encoding in a network page, such as a web page. Similarly, in various embodiments, the communication component 100 may comprise a stand-alone application capable of installation and execution within a client device independent of a web browser. In the following discussion, a general description of a system employing the communication component 100 and various other components is provided, followed by a discussion of the operation of the same.

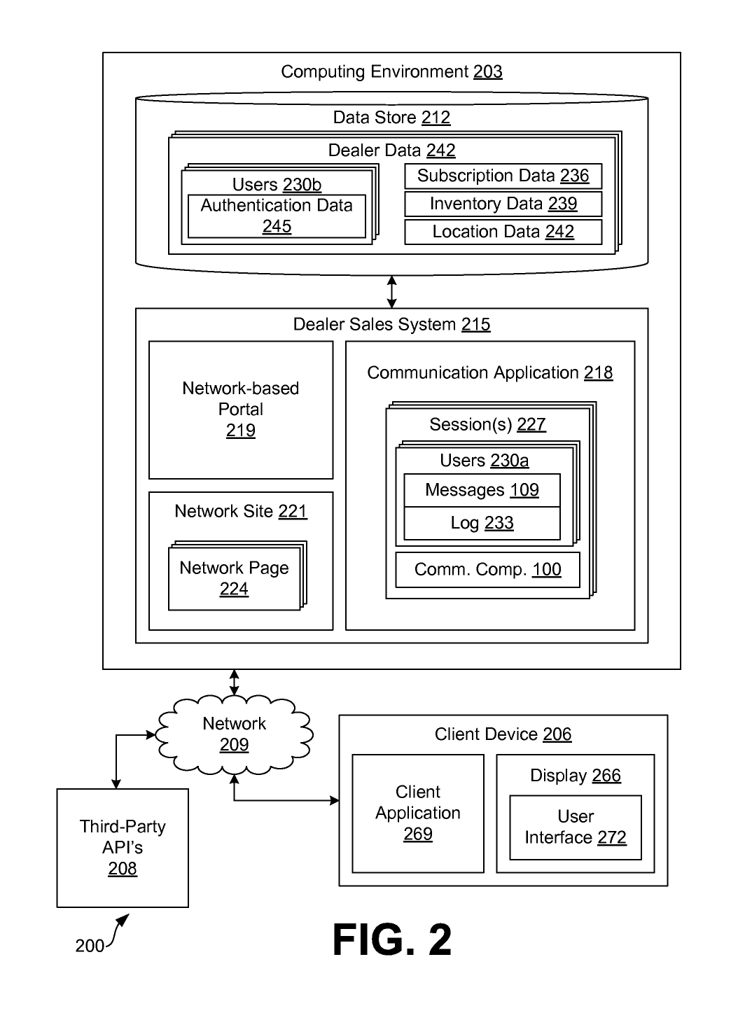

With reference to FIG. 2, shown is a networked environment 200 according to various embodiments. The networked environment 200 includes a computing environment 203, a client device 206, and/or one or more third-party application programming interfaces (APIs), which are in data communication with each other via a network 209. The network 209 includes, for example, the Internet, intranets, extranets, wide area networks (WANs), local area networks (LANs), wired networks, wireless networks, or other suitable networks, etc., or any combination of two or more such networks. For example, such networks may comprise satellite networks, cable networks, Ethernet networks, and other types of networks.

The computing environment 203 may comprise, for example, a server computer or any other system providing computing capability. Alternatively, the computing environment 203 may employ a plurality of computing devices that may be arranged, for example, in one or more server banks or computer banks or other arrangements. Such computing devices may be located in a single installation or may be distributed among many different geographical locations. For example, the computing environment 203 may include a plurality of computing devices that together may comprise a hosted computing resource, a grid computing resource and/or any other distributed computing arrangement. In some cases, the computing environment 203 may correspond to an elastic computing resource where the allotted capacity of processing, network, storage, or other computing-related resources may vary over time.

Various applications and/or other functionality may be executed in the computing environment 203 according to various embodiments. Also, various data is stored in a data store 212 that is accessible to the computing environment 203. The data store 212 may be representative of a plurality of data stores 212 as can be appreciated. The data stored in the data store 212, for example, is associated with the operation of the various applications and/or functional entities described below.

The components executed on the computing environment 203, for example, include a dealer sales system 215, a communication application 218, and other applications, services, processes, systems, engines, or functionality not discussed in detail herein. The dealer sales system 215 is executed to provide a user with the ability to search or otherwise navigate a plurality of inventories via a network-based portal 219, wherein each of the inventories correspond to a respective dealer. The network-based portal 219 may comprise, for example, a network site 221 which encodes one or more network pages 224 for rendering on the client device 206.

The communication application 218 is configured to provide the user conducting the search for a particular item the ability to communicate in real-time with a respective dealer who may have the particular item in its inventory. The communication application 218 may provide one or more sessions 227 for each of the users, where each of the session is a particular communication session 227 between two or more dealers. Accordingly, each session 227 may be associated with respective users 230a of the dealer sales system 215 and/or communication application 218. The communication application 218 may maintain a log 233 comprising each of the messages 109 generated during a particular session 227.

The dealer sales system 215 may further comprise a communication component 100 as described above with respect to FIG. 1. For example, a communication component 100 may be employed to facilitate real-time communication among a plurality of dealers. As may be appreciated, a client device may be configured to generate text based on input provided to the client device via a keyboard, mouse, speech recognition software, gesture recognition software, etc., in response to actions performed by a user of the client device. The communication component 100 accordingly may receive input from one dealer and, in real-time or near real-time, communicate the input to one or more other dealers. The communication component 100 may comprise one or more messages 109a and 109b that may be have been communicated by respective dealers.

The data stored in the data store 212 includes, for example, data associated with the users 230b, subscription data 236, inventory data 239, location data 242, and potentially other data. Users 230b may comprise any information associated with the one or more users of the dealer sales system 215 and/or the communication application 218. Authentication data 245 may be used to authenticate a user prior to and/or during use of the dealer sales system 215 and/or the communication application 218. Accordingly, authentication data 245 may comprise, for example, a user name, a password, a pin number, biometric data, and/or any other information that may be used to authenticate a user 230.

Subscription data 236 may comprise, for example, information related to a subscription provided to a user in exchange for a payment. For example, certain features or access may be provided to a user 230 respective of a subscription level associated with the user 230. Accordingly, different subscription levels provided varying features or levels of access may be offered to the user 230 at different prices. Subscription data 236 may also be used in the automated billing of the user 230.

Inventory data 239 may comprise information associated with inventories for respective dealers. Inventory data 239 may be obtained, for example, by communicating with third-party APIs 208 offered by the dealers or other services. Alternatively, inventory data 239 may be obtained by the dealer via the dealer sales system 215, for example, by prompting the dealer with information about its inventory by generating one or more user interfaces 272.

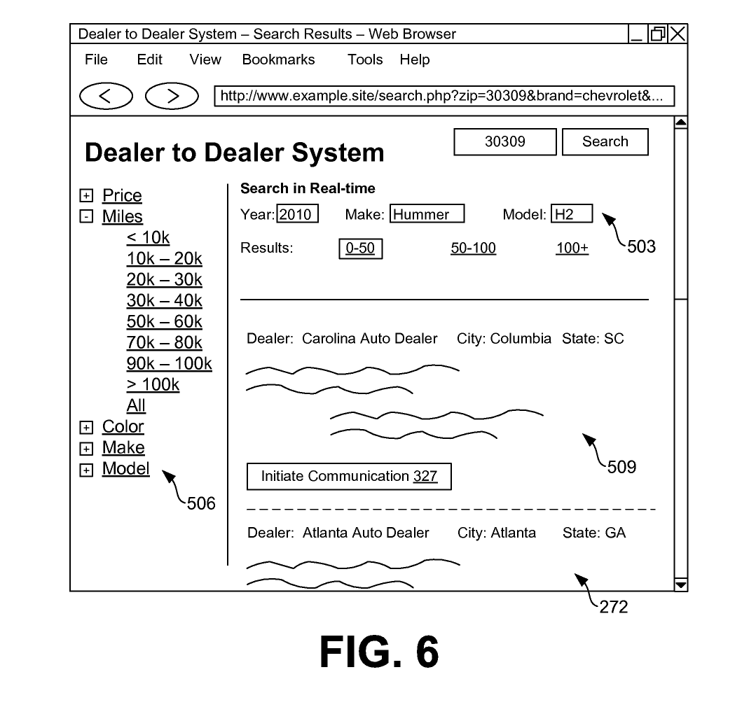

According to various embodiments of the present disclosure, the dealer sales system 215 may not employ inventory data 239. For example, the dealer sales system 215 may be an inventory-less system that provides a communication application 218 between two dealers based on a search query and/or a response to the search query, as will be discussed in greater detail below with respect to FIG. 6. Location data 242 may comprise information associated with the location of the users 230, the dealers, the items of inventory, and/or any other location information. The use of location data 242 will be described in greater detail below.

The client device 206 is representative of one or more client devices that may be coupled to the network 209. The client device 206 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, or other devices with like capability. The client device 206 may include a display 266. The display 266 may comprise, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The client device 206 may be configured to execute various applications such as a client application 269 and/or other applications. The client application 269 may be executed in a client device 206, for example, to access network content served up by the computing environment 203 and/or other servers, thereby rendering a user interface 272 on the display 266. To this end, the client application 269 may comprise, for example, a browser, a dedicated application, etc., and the user interface 272 may comprise a network page, an application screen, etc. The client device 206 may be configured to execute applications beyond the client application 269 such as, for example, email applications, social networking applications, word processors, spreadsheets, and/or other applications.

Next, a general description of the operation of the various components of the networked environment 200 is provided. To begin, it is assumed a dealer, buyer, or merchant is looking for a specific item such as an automobile offered, for example, by another dealer. As described in the example above, a potential customer may have requested a particular vehicle from a dealer who may not have the particular in inventory. Accordingly, the dealer may initiate a request (e.g., a search query) for the particular vehicle via the dealer sales system 215.

According to various embodiments, a search query may comprise, for example, a request for a particular type of automobile, ATV, boat, or other vehicle or item received from a user of the client device 206. The request may be initiated by employing a search tool or other similar component. In response to the search query one or more dealers with the particular item in its inventory may be identified. This may be conducted by comparing the particular item with inventories in the data store 212 corresponding to particular dealers or by communicating with third-party APIs 208, as described above. A ranking of the dealers may be generated according to a relevancy determined for each of the dealers in association with the item subject to the first request. According to various embodiments, the relevancy of each of the dealers may be determined based on, for example, a price of the item offered by a respective dealer, a location of the dealer respective of the user conducting the search, a rating of the dealer, a likelihood the dealer may be respond to a communication attempt, and/or any other information.

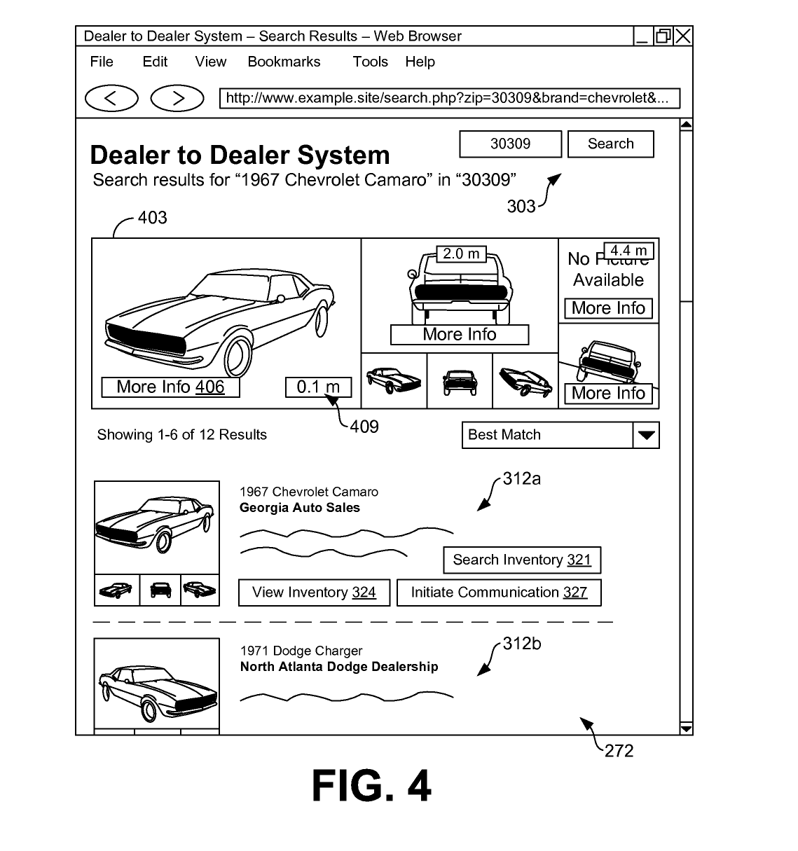

According to various embodiments, a visualized list of items of inventory corresponding to the dealers ranked above may be generated. The visualized list may be arranged according to a relevancy of the item and/or a relevancy of a corresponding dealer selling the item. The visualized list will be described in greater detail below with respect to FIG. 4.

Next, a list of the dealers may be generated. According to various embodiments, the list may be generated according to the ranking determined above. In various embodiments, a top most one of the dealers (e.g., the dealer located at a top of the list) is a most relevant dealer and the bottom most (e.g., the dealer located at a bottom of the list) one of the dealers is a least relevant dealer, although other presentations of the dealers in the list may be employed.

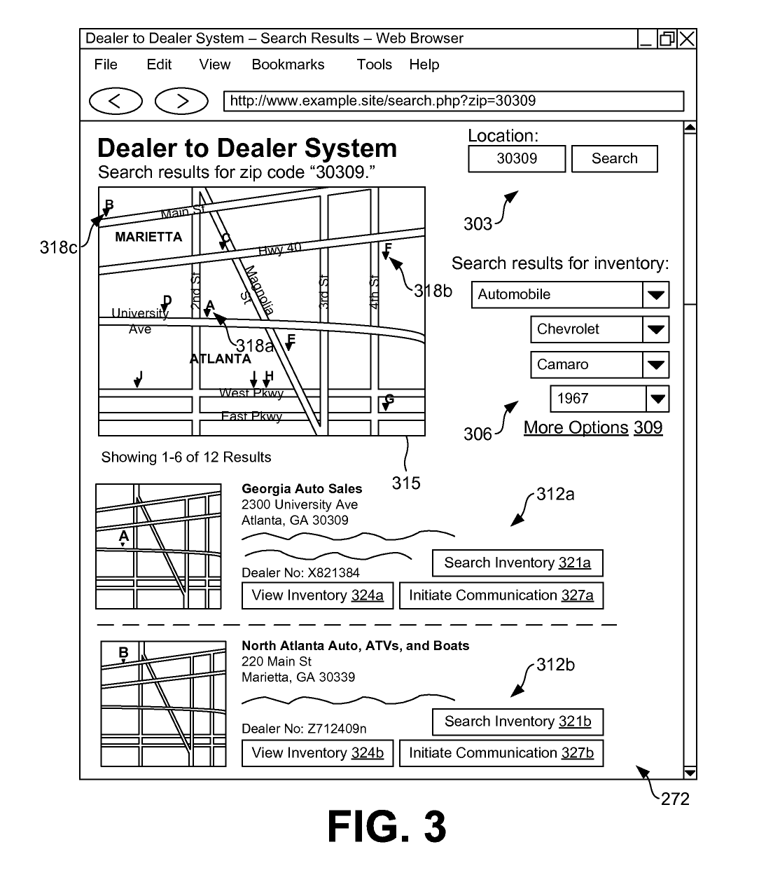

In various embodiments, a map comprising one or more icons corresponding to locations for each of the dealers may be generated. According to various embodiments, the map may be generated or encoded such that when a respective one of the icons is manipulated, a rendering of one or more subsequent user interfaces comprising an information page corresponding to a manipulated one of the icons may be initiated. The information page may comprise, for example, information about the respective dealer such as the dealer's location, inventory, prior communications, and/or any other information. The generation of the map will be discussed in greater detail below with respect to FIG. 3.

Next, the list of dealers, the visualized list of items, and/or the map may be encoded in a user interface 272, such as a network page 224 or a mobile application user interface. According to various embodiments, a component for each of the dealers in the list of the dealers may be generated, wherein the component is configured to initiate a communication session in response to a manipulation of the component by the user. For example, upon a manipulation of the component, a communication component 100 (FIG. 1) may be generated, sent to the client device 206, and rendered in the display 266.

The user interface comprising the one or more features described above may be sent to a client device 206 for rendering in the display 266. It may then be determined whether the user of the client device 206 has initiated a communication session, for example, by manipulating the component described above. If the user has manipulated the component, a communication session may be attempted with the respective dealer associated with the manipulated component. For example, a communication component 100 may be encoded and generated for both the user and the dealer subject to a request.

According to various embodiments, it may be determined whether an agreement has been reached between the user and the dealer. If so, a financial transaction between the respective dealers subject to the communication session may be initiated or otherwise facilitated. For example, a series of subsequent user interfaces may be generated and provided to each of the parties subject to the financial transaction, prompting for terms of the financial transaction. The dealer inventory system 100 may communicate with various payment gateways, such as Checkout by Amazon®, Google® Wallet, PayPal®, or any similar service, to conduct the financial transaction according to the terms agreed upon by the dealers.

Referring next to FIG. 3, shown is a pictorial diagram of an example user interface 272 rendered by a client device 206 (FIG. 2) in the networked environment 200 (FIG. 2) according to various embodiments of the present disclosure. In the non-limiting example of FIG. 3, shown is an example of a search conducted by a user for a particular zip code (i.e., “30309”) and a particular item (i.e., “1967 Chevrolet® Camaro”). Accordingly, a location search component 303 may be operable to receive input by the user in the form of a location, such as a city, state, country, or zip code. As may be appreciated, a user may input an address, zip code, city, state, country, etc., and a number of dealers within a predefined range may be returned to the user conducting the location search via the location search component. According to various embodiments, the predefined range may be specified by a user via the user interface 272. Alternatively, the predefined range may be specified by an administrator or operator of the dealer sales system 215.

Similarly, an item search component 306 may be operable to receive input by the user in the form of characteristics of the item. Although the non-limiting example of FIG. 3, shows characteristics as a type (e.g., “automobile”), a make (e.g., “Chevrolet®”), a model (e.g., “Camaro”), and a year (e.g., “1967”), the present disclosure is not limited to automobiles. For example, other items may be searched including, but not limited to, all terrains vehicles (ATVs), motorcycles, recreational vehicles (RVs), campers, boats, and/or other vehicles or items sold by dealers. Similarly, the search is not limited to the shown characteristics of the item. A more options component 309 (e.g., in the form of a button or a hyperlink) may be manipulated by a user to provide additional criteria to be used in the search for a particular item.

In response to the search, a list of search results comprising one or more dealers (e.g., dealers 312a and 312b), may be determined and encoded in the user interface 272 for display. The list of dealers may be presented according to a relevancy of each of the dealers respective of the user and/or the search conducted by the user. Accordingly, a ranking of the dealers may be generated according to a relevancy determined for each of the dealers. According to various embodiments, the relevancy of each of the dealers may be determined based on, for example, a price of the item offered by a respective dealer, a location of the dealer respective of the user conducting the search, a rating of the dealer, a likelihood the dealer may be respond to a communication attempt, and/or any other information.

A map 315 comprising one or more icons (e.g., icons 318a, 318b, and 318c) corresponding to locations for each of the dealers may be generated. According to various embodiments, the map 315 may be generated or encoded such that when a respective one of the icons 318 is manipulated, a rendering of one or more subsequent user interfaces 272 comprising an information page corresponding to a manipulated one of the icons may be initiated. The information page may comprise, for example, information about the respective dealer such as the dealer's location, inventory, prior communications, and/or any other information.

For each of the dealers 312 in the list, various components may be shown in association with the respective dealer 312. For example, a search inventory component (e.g., search inventory components 321a and 321b) may be configured such that when manipulated, one or more additional user interfaces 272 are rendered facilitating the searching of an inventory for the particular dealer 312. Similarly, a view inventory component (e.g., view inventory components 324a and 324b) may be configured such that when manipulated, one or more additional user interfaces 272 are rendered facilitating the viewing of an inventory for the particular dealer 312. An initiate communication component (e.g., initiate communication components 327a and 327b) may be configured such that when manipulated, one or more additional user interfaces 272 are rendered facilitating a communication between the user and the respective dealer, as will be discussed in greater detail below.

Turning now to FIG. 4, shown is a pictorial diagram of an example user interface 272 rendered by a client device 206 (FIG. 2) in the networked environment 200 (FIG. 2) according to various embodiments of the present disclosure. In the non-limiting example of FIG. 4, shown is another example of a search conducted by a user for a particular zip code (i.e., “30309”) and a particular item (i.e., “1967 Chevrolet® Camaro”). Accordingly, a location search component 303 may be operable to receive input by the user in the form of a location, such as a city, state, country, or zip code. Although the non-limiting example of FIG. 4 shows a search for a particular type of automobile, the present disclosure is not so limited. For example, other items may be searched including, but not limited to, all terrains vehicles (ATVs), motorcycles, recreational vehicles (RVs), campers, boats, and/or other items sold by dealers.

In the non-limiting example of FIG. 4, a visualized list of items of inventory corresponding to the dealers may be generated. The visualized list may be arranged according to a relevancy of the item, a relevancy of a corresponding dealer selling the item, a ranking of the item, and/or a ranking of the dealer selling the item. As a non-limiting example, the visualized list may comprise the visualization region 403 generated in FIG. 4, wherein the visualization region comprises one or more images of the item subject to the search and, for example, accessed from a data store. According to various embodiments, each of the images may be provided by the dealers or otherwise accessed from the dealers, for example, via the third-party APIs 208. For each of the images, a more information component 406 may be generated such that, when manipulated, more information about the item or the dealer selling the item may be rendered. Similarly, a distance component 409 may be generated to provide the user with a distance of the item or the dealer respective of the user, for example, utilizing a global positioning system (GPS), an address of the user, an address of the dealer, location data 242 (FIG. 2) accessed from the data store 212 (FIG. 2), and/or other information.

As discussed above with respect to FIG. 3, for each of the dealers 312 in the list of search results, various components may be shown in association with a respective dealer 312 (e.g., dealers 312a and 312b). For example, a search inventory component 321 may be configured such that when manipulated, one or more additional user interfaces 272 are rendered facilitating the searching of an inventory for the particular dealer 312. Similarly, a view inventory component (e.g., view inventory components 324a and 324b) may be configured such that when manipulated, one or more additional user interfaces 272 are rendered facilitating the viewing of an inventory for the particular dealer 312. An initiate communication component (e.g., initiate communication components 327a and 327b) may be configured such that when manipulated, one or more additional user interfaces 272 are rendered facilitating a communication between the user and the respective dealer, as will be discussed in greater detail below.

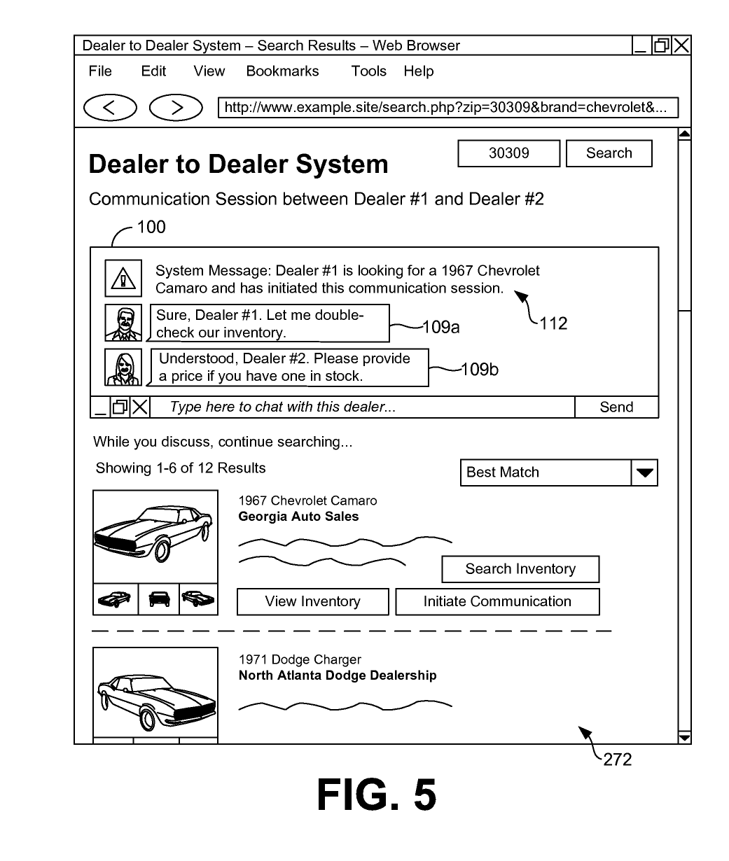

Moving on to FIG. 5, shown is a pictorial diagram of an example user interface 272 rendered by a client device 206 (FIG. 2) in the networked environment 200 (FIG. 2) according to various embodiments of the present disclosure. In the non-limiting example of FIG. 5, a user interface 272 may comprise, for example, the communication component 100, described above with respect to FIG. 1, that may be employed to facilitate real-time communication among a plurality of dealers. The communication component 100 is configured to receive input from one dealer and, in real-time or near real-time, communicate the input to one or more other dealers in response to a user manipulating or engaging the send component 103. The communication component 100 may comprise one or more messages 109a and 109b that may be have been communicated by respective dealers. According to various embodiments, upon initiating a communication session, the system may provide context of the communication session in the form of a system message 112. The system message 112 may comprise at least an item searched by one of the dealers which led to the initiation of the communication session facilitated by the communication component 100. For example, a search for the 1967 Chevrolet® Camaro led to the initiation of the communication session between the user and a particular dealer 312. Accordingly, the system message 112 may notify both parties of the context of the communication session by providing the vehicle (or other item) subject to the search.

As discussed above with respect to FIG. 1, the communication component 100 may be configured as a software widget for encoding in a network page, such as a web page. Similarly, in various embodiments, the communication component 100 may comprise a stand-alone application capable of installation and execution within a client device independent of a web browser.

Turning now to FIG. 6, shown is a pictorial diagram of an example user interface 272 rendered by a client device 206 (FIG. 2) in the networked environment 200 (FIG. 2) according to various embodiments of the present disclosure. In the non-limiting example of FIG. 6, shown is another example of a user interface 272 that may be generated as a network-based portal 219 to facilitate a real-time search for vehicles, or similar items, to initiate a communication session between a buyer and a dealer. As the non-limiting example described with respect to FIG. 6 is conducted in real-time, it may be assumed that the search for a vehicle may be conducted without a need for an inventory database. Assume a dealer or a buyer has conducted a search for a Hummer H2 vehicle, as shown in FIG. 6, using a search field 503. An item taxonomy 506 may be encoded in the user interface 272 to facilitate the navigation of search results 509, for example, my engaging hyperlinks corresponding to terms that may dial down search results, wherein the terms comprise, for example, “price, miles, color, make, model,” etc.

As the search is conducted in real-time, various dealers may be notified via SMS (e.g., text message), e-mail, alert dialog in the network-based portal 219, etc. of the search conducted. The notification may facilitate the ability of the dealer to participate in the search as a dealer shown in the search results. For example, a dealer may receive a text message for the Hummer H2. If the dealer has one in stock, or if the dealer knows of one to be located, the dealer may reply to the text to be included in the search results. Accordingly, in the non-limiting example of FIG. 6, the search results 509 may be encoded in the user interface 272 showing features of various items located in the search provided by the dealer, for example, when responding to the search alert. The search results 509 may be arranged according to a time in which the dealer responds, a relevancy of the item, a relevancy of a corresponding dealer selling the item, a ranking of the item, and/or a ranking of the dealer selling the item. As a non-limiting benefit, the user interface 272 of FIG. 6 facilitates a quick, minimal inspection of vehicles.

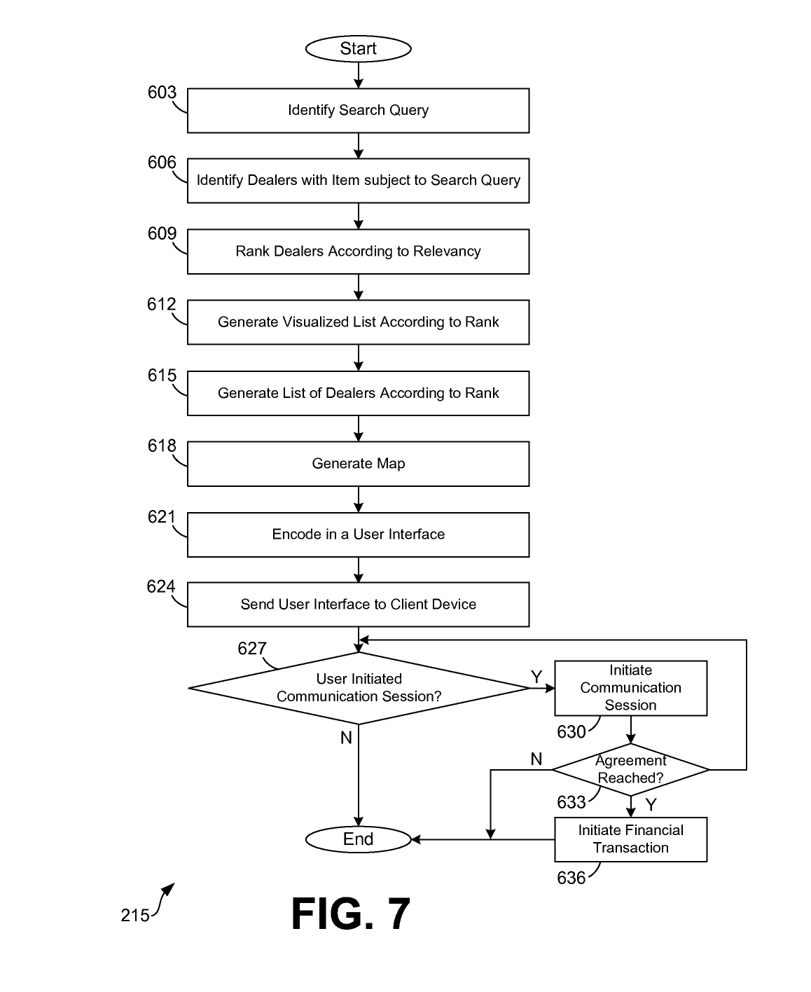

Referring next to FIG. 7, shown is a flowchart that provides one example of the operation of a portion of the dealer sales system 215 according to various embodiments. It is understood that the flowchart of FIG. 7 provides merely an example of the many different types of functional arrangements that may be employed to implement the operation of the portion of the dealer sales system 215 as described herein. As an alternative, the flowchart of FIG. 7 may be viewed as depicting an example of elements of a method implemented in the computing environment 203 (FIG. 2) according to one or more embodiments.

Beginning with 603, a search query may be identified. According to various embodiments, the search query may comprise, for example, a request for a particular type of automobile, ATV, boat, or other item received from a user of the client device 206 (FIG. 2). The request may be initiated by employing a search tool or other similar component. In response to the search query, in 606, one or more dealers with the particular item in its inventory may be identified. This may be conducted by comparing the particular item with inventories in the data store 212 (FIG. 2) corresponding to particular dealers or by communicating with third-party APIs 208, as described above.

In 609, a ranking of the dealers may be generated according to a relevancy determined for each of the dealers in association with the item subject to the first request. According to various embodiments, the relevancy of each of the dealers may be determined based on, for example, a price of the item offered by a respective dealer, a location of the dealer respective of the user conducting the search, a rating of the dealer, a likelihood the dealer may be respond to a communication attempt, and/or any other information.

According to various embodiments, in 612, a visualized list of items of inventory corresponding to the dealers ranked in 609 may be generated. The visualized list may be arranged according to a relevancy of the item and/or a relevancy of a corresponding dealer selling the item. As a non-limiting example, the visualized list may comprise the visualization region 403 generated in FIG. 4.

Subsequently, in 615, a list of the dealers may be generated. According to various embodiments, the list may be generated according to the ranking determined in 609. In various embodiments, a top most one of the dealers (e.g., the dealer located at a top of the list) is a most relevant dealer and the bottom most (e.g., the dealer located at a bottom of the list) one of the dealers is a least relevant dealer, although other presentations of the dealers in the list may be employed.

In 618, a map 315 (FIG. 3) comprising one or more icons corresponding to locations for each of the dealers may be generated. According to various embodiments, the map may be generated or encoded such that when a respective one of the icons is manipulated, a rendering of one or more subsequent user interfaces comprising an information page corresponding to a manipulated one of the icons may be initiated. The information page may comprise, for example, information about the respective dealer such as the dealer's location, inventory, prior communications, and/or any other information.

Subsequently, in 621, the list of dealers, the visualized list of items, and/or the map 315 may be encoded in a user interface, such as a network page or a mobile application user interface. According to various embodiments, a component for each of the dealers in the list of the dealers may be generated, wherein the component is configured to initiate a communication session in response to a manipulation of the component by the user. For example, upon a manipulation of the component, a communication component 100 may be generated, sent to the client device 206 (FIG. 2), and rendered in the display 266 (FIG. 2).

In 624, the user interface comprising the one or more features described above may be sent to a client device 206 for rendering in the display 266. In 627, it may be determined whether the user of the client device 206 has initiated a communication session, for example, by manipulating the component described above with respect to 621. If the user has not manipulated the component, the flowchart proceeds to end. Alternatively, if the user has manipulated the component, in 630, a communication session may be attempted with the respective dealer associated with the manipulated component. For example, a communication component 100 may be encoded and generated for both the user and the dealer subject to the request. According to various embodiments, it may be determined whether an agreement has been reached, as shown in 633. If so, in 636, a financial transaction between the respective dealers subject to the communication session may be initiated or otherwise facilitated. For example, a series of subsequent user interfaces may be generated and provided to each of the parties subject to the financial transaction, prompting for terms of the financial transaction. The dealer inventory system 100 may communicate with various payment gateways, such as Checkout by Amazon®, Google® Wallet, PayPal®, or any similar service, to conduct the financial transaction according to the terms agreed upon by the dealers. If no agreement is reached among the dealers, the flowchart may end, as depicted in FIG. 7.

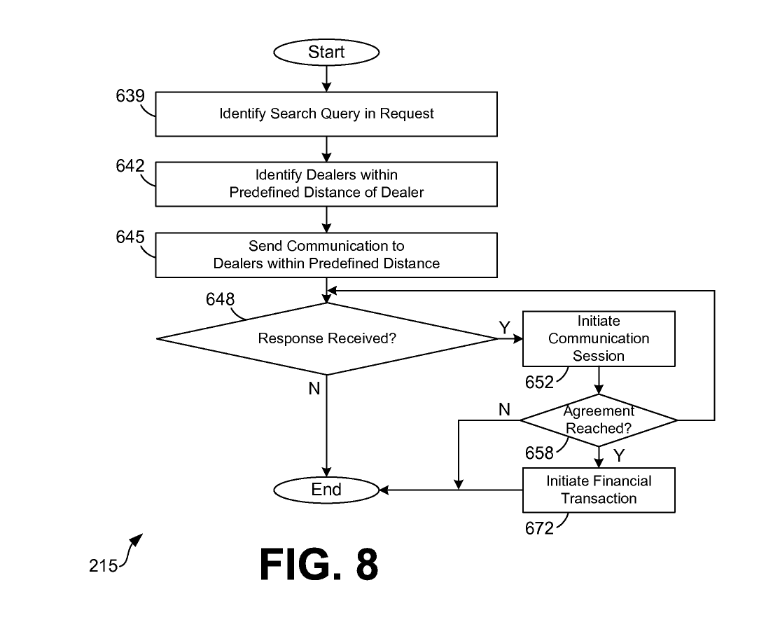

Referring next to FIG. 8, shown is a flowchart that provides one example of the operation of a portion of the dealer sales system 215 according to various embodiments. It is understood that the flowchart of FIG. 8 provides merely an example of the many different types of functional arrangements that may be employed to implement the operation of the portion of the dealer sales system 215 as described herein. As an alternative, the flowchart of FIG. 8 may be viewed as depicting an example of elements of a method implemented in the computing environment 203 (FIG. 2) according to one or more embodiments.

Beginning with 639, a search query may be identified. According to various embodiments, the search query may comprise, for example, a request for a particular type of automobile, ATV, boat, or other item received from a user of the client device 206 (FIG. 2). The request may be initiated by employing a search tool or other similar component and may comprise other predefined criteria specified by the user, such as desired features of the vehicle. In response to the search query, in 642, one or more dealers within a predefined location of the user performing the request may be identified by comparing a location specified by the user to locations of other dealers. This may include performing an analysis of location data 242.

Next in 645, a communication is sent to the others ones of the dealers located within the predefined distance. The communication may specify the vehicle and the predefined criteria defined in the search query. In various embodiments, the communication sent to the others ones of the dealers is selected from a group consisting of an email, an instant message, and an SMS message.

Next in 648, it is determined whether at least one response identifying whether a corresponding one of the other ones of the dealers has the item required by the user has been received. For example, a dealer receiving the communication may indicate that he wishes to speak with the originator of the search query. If so, in 652, a communication session is generated in a user interface in response to the corresponding one of the plurality of dealers having the item required by the user. As may be appreciated, the communication session is operable to conduct bi-lateral communication between the user and at least one of the dealers having the item required by the user.

For example, a communication component 100 may be encoded and generated for both the user and the dealer having the item required by the user. In various embodiments, the messages sent by either dealers may be stored in the data store 212. However, in alternative embodiments, the messages may be discarded or deleted once they have been sent to the other user.

According to various embodiments, it may be determined whether an agreement has been reached, as shown in 658. If so, in 672, a financial transaction between the respective dealers subject to the communication session may be initiated or otherwise facilitated. For example, a series of subsequent user interfaces may be generated and provided to each of the parties subject to the financial transaction, prompting for terms of the financial transaction. The dealer inventory system 100 may communicate with various payment gateways, such as Checkout by Amazon®, Google® Wallet, PayPal®, or any similar service, to conduct the financial transaction according to the terms agreed upon by the dealers. If no agreement is reached among the dealers, the flowchart may end, as depicted in FIG. 8.

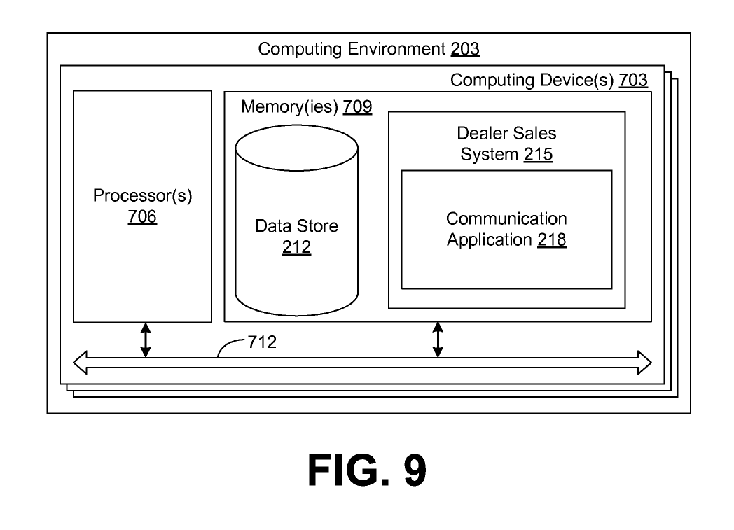

With reference to FIG. 9, shown is a schematic block diagram of the computing environment 203 according to an embodiment of the present disclosure. The computing environment 203 includes one or more computing devices 703. Each computing device 703 includes at least one processor circuit, for example, having a processor 706 and a memory 709, both of which are coupled to a local interface 712. To this end, each computing device 703 may comprise, for example, at least one server computer or like device. The local interface 712 may comprise, for example, a data bus with an accompanying address/control bus or other bus structure as can be appreciated.

Stored in the memory 709 are both data and several components that are executable by the processor 706. In particular, stored in the memory 709 and executable by the processor 706 are the dealer sales system 215, the communication application 218, and potentially other applications. Also stored in the memory 709 may be a data store 212 and other data. In addition, an operating system may be stored in the memory 709 and executable by the processor 706.

It is understood that there may be other applications that are stored in the memory 709 and are executable by the processor 706 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 709 and are executable by the processor 706. In this respect, the term “executable” means a program file that is in a form that can ultimately be run by the processor 706. Examples of executable programs may be, for example, a compiled program that can be translated into machine code in a format that can be loaded into a random access portion of the memory 709 and run by the processor 706, source code that may be expressed in proper format such as object code that is capable of being loaded into a random access portion of the memory 709 and executed by the processor 706, or source code that may be interpreted by another executable program to generate instructions in a random access portion of the memory 709 to be executed by the processor 706, etc. An executable program may be stored in any portion or component of the memory 709 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 709 is defined herein as including both volatile and nonvolatile memory and data storage components. Volatile components are those that do not retain data values upon loss of power. Nonvolatile components are those that retain data upon a loss of power. Thus, the memory 709 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 706 may represent multiple processors 706 and/or multiple processor cores and the memory 709 may represent multiple memories 709 that operate in parallel processing circuits, respectively. In such a case, the local interface 712 may be an appropriate network that facilitates communication between any two of the multiple processors 706, between any processor 706 and any of the memories 709, or between any two of the memories 709, etc. The local interface 712 may comprise additional systems designed to coordinate this communication, including, for example, performing load balancing. The processor 706 may be of electrical or of some other available construction.

Although the dealer sales system 215, the communication application 218, and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowchart of FIG. 7 shows the functionality and operation of an implementation of portions of the dealer sales system 215 and/or the communication application 218. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 706 in a computer system or other system. The machine code may be converted from the source code, etc. If embodied in hardware, each block may represent a circuit or a number of interconnected circuits to implement the specified logical function(s).

Although the flowchart of FIG. 7 shows a specific order of execution, it is understood that the order of execution may differ from that which is depicted. For example, the order of execution of two or more blocks may be scrambled relative to the order shown. Also, two or more blocks shown in succession in FIG. 7 may be executed concurrently or with partial concurrence. Further, in some embodiments, one or more of the blocks shown in FIG. 7 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the dealer sales system 215, the communication application 218, that comprises software or code can be embodied in any non-transitory computer-readable medium for use by or in connection with an instruction execution system such as, for example, a processor 706 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the dealer sales system 215, the communication application 218, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 703, or in multiple computing devices in the same computing environment 203. Additionally, it is understood that terms such as “application,” “service,” “system,” “engine,” “module,” and so on may be interchangeable and are not intended to be limiting.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A computer-implemented method for providing a bi-lateral communication between a plurality of dealers having a network presence, comprising:
receiving, by at least one computing device comprising at least one hardware processor, a request for a vehicle matching predefined criteria from a client device over a network, the predefined criteria specified in the request by a first one of the dealers using a user interface generated by the at least one computing device to perform a search for the vehicle;
identifying, by the at least one computing device, in response to a receipt of the request, other ones of the dealers located within a predefined distance of the first one of the dealers by generating a query for the other ones of the dealers from a database accessed from a data store, wherein the data store does not comprise a listing of inventory for the dealers;
sending, by the at least one computing device, a communication to the others ones of the dealers located within the predefined distance comprising the vehicle and the predefined criteria;
receiving, by the at least one computing device, at least one response identifying whether a corresponding one of the other ones of the dealers has the item required by the user; and
generating, by the at least one computing device, a communication session in a user interface in response to the corresponding one of the plurality of dealers having the item required by the user, wherein the communication session is operable to conduct bi-lateral communication between the user and at least one of the dealers associated with the request in the user interface.

2. The computer-implemented method of claim 1, wherein the program further comprises code that generates a visualization region to be encoded in the network page, wherein the visualization region comprises a plurality of images of the item accessed from a data store, each of the plurality of images provided by the dealers.

3. The computer-implemented method of claim 1, wherein the bi-lateral communication is operable to be conducted in real-time.

4. The computer-implemented method of claim 1, further comprising generating, by the at least one computing device, a map comprising a plurality of icons corresponding to locations for each of the dealers, wherein the icons, when manipulated by the first one of the dealers, initiate a rendering of at least one subsequent user interface comprising an information page corresponding to a manipulated one of the icons.

5. The computer-implemented method of claim 4, further comprises encoding, by the at least one computing device, the map in the user interface.

6. The computer-implemented method of claim 1, wherein the user interface further comprises a network page accessible over a network.

7. A system for providing bi-lateral communication between a plurality of dealers, comprising:
at least one computing device comprising at least one hardware processor and a data store; and
an application executed in the at least one computing device, the application comprising logic that:
receives a request for a vehicle matching predefined criteria from a client device over a network, the predefined criteria specified in the request by a first one of the dealers using a user interface generated by the at least one computing device to perform a search for the vehicle;
identifies, in response to a receipt of the request, other ones of the dealers located within a predefined distance of the first one of the dealers;
sends a communication to the others ones of the dealers located within the predefined distance comprising the vehicle and the predefined criteria;
receives at least one response identifying whether a corresponding one of the other ones of the dealers has the item required by the user; and
generates a communication session in a user interface in response to the corresponding one of the plurality of dealers having the item required by the user, wherein the communication session is operable to conduct bi-lateral communication between the user and at least one of the dealers associated with the request in the user interface.

8. The system of claim 7, wherein the data store does not comprise a listing of inventory for the dealers;

9. The system of claim 7, wherein the logic that identifies, in response to the receipt of the request, other ones of the dealers located within a predefined distance of the first one of the dealers further comprises logic that generates a query for the other ones of the dealers from a database accessed from the data store.

10. The system of claim 7, wherein the bi-lateral communication is operable to be conducted in real-time.

11. The system of claim 7, wherein the communication sent to the others ones of the dealers is selected from a group consisting of an email, an instant message, and a simple messaging service (SMS) message.

12. The system of claim 7, wherein the application further comprises logic that:
generates a map comprising a plurality of icons corresponding to locations for each of the dealers, wherein the icons, when manipulated by the first one of the dealers, initiate a rendering of at least one subsequent user interface comprising an information page corresponding to a manipulated one of the icons; and
encodes the map in the user interface.

13. The system of claim 12, wherein the user interface further comprises a network page accessible over a network.

14. A non-transitory computer-readable medium comprising a program executable by at least one computing device configured to provide multi-lateral communication among a plurality of dealers, the program comprising code that, when executed, causes the at least one computing device to:
receive a request for a vehicle matching predefined criteria from a client device over a network, the predefined criteria specified in the request by a first one of the dealers using a user interface generated by the at least one computing device to perform a search for the vehicle;
identify, in response to a receipt of the request, other ones of the dealers located within a predefined distance of the first one of the dealers;
send a communication to the others ones of the dealers located within the predefined distance comprising the vehicle and the predefined criteria;
receive at least one response identifying whether a corresponding one of the other ones of the dealers has the item required by the user; and
generate a communication session in a user interface in response to the corresponding one of the plurality of dealers having the item required by the user, wherein the communication session is operable to conduct bi-lateral communication between the user and at least one of the dealers associated with the request in the user interface.

15. The non-transitory computer-readable medium of claim 14, wherein the data store does not comprise a listing of inventory for the dealers;

16. The non-transitory computer-readable medium of claim 14, wherein the code that identifies, in response to the receipt of the request, other ones of the dealers located within a predefined distance of the first one of the dealers further comprises code that generates a query for the other ones of the dealers from a database accessed from the data store.

17. The non-transitory computer-readable medium of claim 14, wherein the bi-lateral communication is operable to be conducted in real-time.

18. The non-transitory computer-readable medium of claim 14, wherein the communication sent to the others ones of the dealers is selected from a group consisting of an email, an instant message, and a simple messaging service (SMS) message.

19. The non-transitory computer-readable medium of claim 14, wherein the program further comprises code that:
generates a map comprising a plurality of icons corresponding to locations for each of the dealers, wherein the icons, when manipulated by the first one of the dealers, initiate a rendering of at least one subsequent user interface comprising an information page corresponding to a manipulated one of the icons; and
encodes the map in the user interface.

20. The non-transitory computer-readable medium of claim 19, wherein the user interface further comprises a network page accessible over a network.
